(19) United States
(12) Patent Application Publication
(10) Pub. No.: US 2026/0105454 A1
(43) Pub. Date: Apr. 16, 2026

(54) SYSTEM TRANSCEIVER REMOTE CONTROL OF A USER TRANSCEIVER

(71) Applicant: Truist Bank, Charlotte, NC (US)

(72) Inventors: Jamie Nathaniel Franklin, Charlotte, NC (US); Mary Margaret Mueller, Charlotte, NC (US)

(73) Assignee: Truist Bank, Charlotte, NC (US)

(21) Appl. No.: 18/917,312

(22) Filed: Oct. 16, 2024

(51) Int. Cl. G06Q 20/40; G06Q 20/10; G06Q 20/20; G06Q 20/32; H04L 51/04

(52) U.S. Cl. CPC G06Q 20/4015; G06Q 20/102; G06Q 20/208; G06Q 20/3224; G06Q 20/4016; H04L 51/04

(57) ABSTRACT

A system transceiver is configured to determine a geographic location at which a data transfer associated with conducting a transaction is initiated during use of an interactive device associated with a second user, to automatically generate a communication including information regarding the determined geographic location at which the data transfer was initiated during the use of the interactive device associated with the second user, and to automatically send the communication to a first transceiver associated with a first user. The information regarding the determined geographic location at which the data transfer was initiated includes one of a reporting of a geographic boundary in which the data transfer is determined to have occurred or a mapping of the geographic location at which the data transfer is determined to have occurred.

### FIELD

This invention relates generally to a mobile banking platform for reporting information regarding transactions associated with a financial account, and more particularly, embodiments of the invention relate to a mobile banking platform that reports information to the user device of one or more of multiple authorized users of the financial account relating to each transaction occurring with respect to the financial account as facilitated by any of the authorized users of the financial account.

### BACKGROUND

Payment cards, such as credit cards, debit cards, and other forms of digital payment instruments, have become a cornerstone of modern commerce. With their widespread use, however, comes an increasing vulnerability to fraudulent activities. A growing concern among users of payment cards is the discovery of unauthorized purchases, which may occur through several avenues. Physical theft of the payment card or an accessible user payment device (mobile device in most circumstances) with digital wallet/mobile payment capabilities may result in fraudulent in-person transactions conducted by individuals who do not have the permission of any associated cardholder. Additionally, fraudulent online transactions may occur even without physical access to the payment card or user payment device, particularly when an identity thief gains access to sensitive cardholder information such as account numbers, expiration dates, security codes, and other personal details that may be utilized in authenticating the identity of a cardholder when attempting to make fraudulent purchases or monetary exchanges on behalf of the cardholder.

Another layer of complexity arises in situations where a single payment card account includes a primary cardholder that is primarily responsible for the payment card account as well as one or more additional authorized users, wherein each such authorized user may also be a (secondary) cardholder with respect to the common payment card account in addition to the primary cardholder. In such cases, the original or primary cardholder may allow each authorized user, which may typically be a family member, employee, business associate, or other trusted representative or agent of the primary cardholder, to have access to and conduct transactions with respect to the payment card account. Each authorized user may be issued a corresponding physical payment card and/or may have access to digital versions of the payment credentials, enabling them to make purchases on behalf of the common account via a variety of different methods. In such circumstances, it is common for the primary cardholder and any such authorized users to make in-person or online transactions substantially contemporaneously and independently, including using their assigned payment cards or digital equivalents at distinct and geographically distant locations. Although online access to the payment card information is generally secured by various methods, the growing sophistication of identity theft has highlighted potential vulnerabilities in providing account access and use to multiple distinct cardholders.

Specifically, the shared access that multiple cardholders have to the same payment card account exacerbates the potential for security breaches. Each physical payment card or digital equivalent represents a potential point of failure, where theft or misuse could lead to unauthorized transactions. Furthermore, the different users authorized to access the account may present varying levels of risk, depending on their diligence in protecting sensitive information. For instance, an authorized user who is less vigilant about safeguarding their card, using secure networks, or employing strong authentication practices could inadvertently expose the entire payment card account to fraud, wherein such accounts are typically subject to an agreement wherein the primary cardholder is liable for any actions taken or frauds perpetrated against any of the authorized users assigned to such a common payment card account. In such cases, the “weakest link” among the group of cardholders can undermine the security of the payment card account as a whole, increasing the likelihood of unauthorized transactions and ultimately liability for one or more parties that may not be directly responsible for such breaches of security.

In light of the security risks associated with both individual and shared access to payment card accounts, there is accordingly a need for systems and methods designed to mitigate these vulnerabilities. More specifically, there is a pressing need for real-time solutions that can quickly identify and respond to fraudulent or unauthorized transactions before they escalate. Such systems would provide immediate detection and resolution mechanisms, ensuring that primary cardholders and authorized users alike are protected from the consequences of identity theft, fraud, or unauthorized use of payment cards, whether in physical or digital form.

### BRIEF SUMMARY

Embodiments of the present invention address the above needs and/or achieve other advantages by providing apparatuses and methods that determine information regarding the geographic location of each secondary cardholder when a transaction with respect to a corresponding shared payment card account is initiated and then report such information to a primary cardholder of the shared payment card account in providing a security feature wherein the primary cardholder can detect and react to potentially suspect transactions in a real time manner.

According to one embodiment of the present invention, a system transceiver for interaction with a first transceiver associated with a first user includes at least one processor, a communication interface communicatively coupled to the at least one processor, and a memory device storing executable code that, when executed, causes the processor to determine a geographic location at which a data transfer is initiated during use of an interactive device associated with a second user, automatically generate a communication including information regarding the determined geographic location at which the data transfer was initiated during the use of the interactive device associated with the second user, and automatically send the communication to the first transceiver associated with the first user.

According to another embodiment of the present invention, a method of operating a system transceiver for interaction with a first transceiver associated with a first user comprises the steps of: determining a geographic location at which a data transfer is initiated during use of an interactive device associated with a second user; automatically generating a communication including information regarding the determined geographic location at which the data transfer was initiated during the use of the interactive device associated with the second user; and automatically sending the communication to the first transceiver associated with the first user.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates an enterprise system and environment thereof for engaging with a user during navigation of a mobile banking platform, in accordance with one embodiment of the present invention.

FIG. 2 is an exemplary display of a mobile device of a primary account user illustrating a graphical representation of the receipt of multiple communications relating to use of a shared payment card account in conducting transactions by multiple secondary account users.

FIG. 3 is an exemplary display of the mobile device of the primary account user illustrating a graphical representation of additional information relating to a first one of the transactions reported to the primary account user and relating to a transaction initiated by a first one of the secondary account users including geographical location information relating to where the first one of the transactions was initiated.

FIG. 4 is an exemplary display of the mobile device of the primary account user illustrating a graphical representation of additional information relating to a second one of the transactions reported to the primary account user and relating to a transaction initiated by a second one of the secondary account users including geographical location information relating to where the second one of the transactions was initiated, wherein the second one of the transactions is flagged as potentially being suspect, fraudulent, or unauthorized based on analysis of the information relating to the determined geographical location of the second one of the secondary account users.

FIG. 5 is an exemplary display of the mobile device of the primary account user illustrating a graphical representation of additional information relating to a third one of the transactions reported to the primary account user and relating to a transaction initiated by a third one of the secondary account users including geographical location information relating to where the third one of the transactions was initiated, wherein the third one of the transactions is flagged as potentially being suspect, fraudulent, or unauthorized based on analysis of the information relating to the determined geographical location of the third one of the secondary account users in comparison to information determined with respect to the geographical location of the primary account user.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

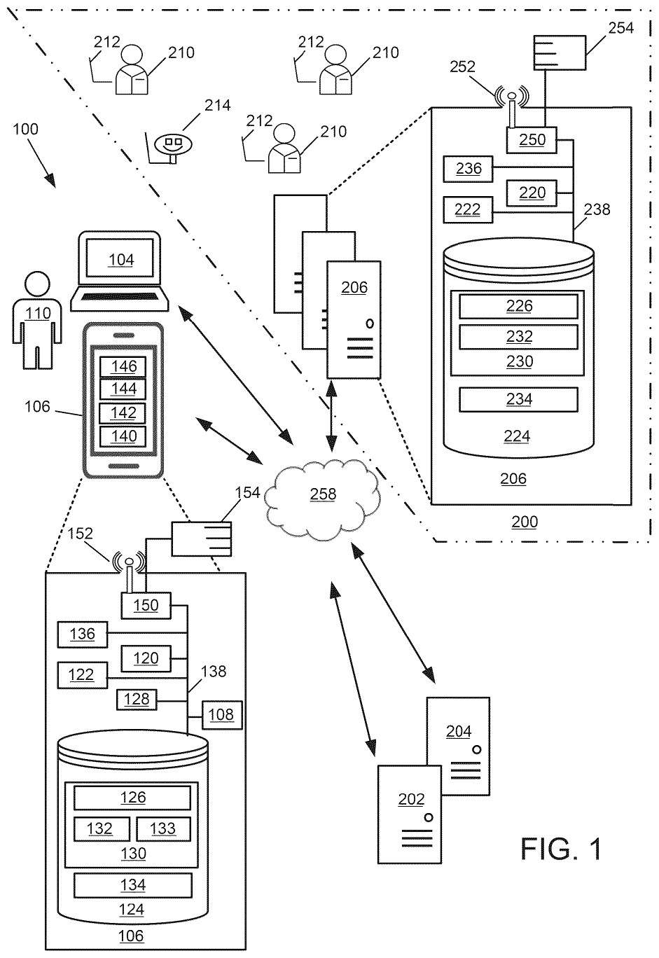

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned or other portable devices with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device. That is, any references hereinafter to only the mobile device 106 may be considered to be inclusive of the computing device 104, wherein the primary differences between the mobile device 106 and the computing device 104 may relate to the manner in which such devices 104, 106 connect to an associated network and the corresponding system components included in each such device 104, 106 for making such network connections. For example, the computing device 104 may in some circumstances include the ability to form only a limited number of network connections via a relatively limited number or variety of different communication devices, methodologies, and/or protocols, such as lacking geolocation tracking capabilities due to a lack of integrated communication interfaces and/or devices, whereas an associated mobile device 106 may include the ability to connect to additional networks in comparison to the computing device 104 in view of the potential availability of an increased number of such communication interfaces and/or devices being integrated into the mobile device 106 and associated with general use thereof. However, it should generally be understood that either of the computing device 104 or the mobile device 106 may include any of the communication interfaces and/or devices as described hereinafter regardless of which type of device 104, 106 is referenced hereinafter in describing the present invention.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device 104, 106, as illustrated with reference to the exemplary mobile device 106 of FIG. 1, includes components including at least one of each of a processing device 120 and a memory device 122 for processing use, such as random access memory (RAM) and/or read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the illustrated application 132 is represented as a particular example. The storage device 124 can store various other data items 134, which can include, as non-limiting examples, cached data, user files such as those for pictures, audio and/or video recordings, files downloaded or received from other devices, and other data items that are preferred by the user or that are required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the user devices 104, 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The user device 104, 106 may also include a positioning device 108, which can be a global positioning system (GPS) device that is configured for utilization by a corresponding positioning system to determine a location of the user device 104, 106. For example, the positioning device 108 may include a GPS transceiver. In some embodiments, the positioning device 108 may include an antenna, transmitter, and receiver. For example, in one embodiment, triangulation of cellular signals may be used to identify the approximate location of the user device 104, 106. In other embodiments, the positioning device 108 includes a proximity sensor or transmitter, such as an RFID tag, that can sense or be sensed by devices known to be located proximate a merchant or other location to determine that the user device 104, 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly - by way of intermediate component(s)-with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS services may be included for navigation and location-related data exchanges, whether ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the mobile device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced generally as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is depicted as a single network in FIG. 1 for illustrative convenience, but the network 258 may further represent more than one network or more than one type of network while remaining within the scope of the present disclosure. In some embodiments, the network 258 may be or may provide one or more cloud-based services or operations. The network 258 may be or may include an enterprise or secured network, or may be implemented, at least in part, through one or more connections to the Internet. A portion of the network 258 may be a virtual private network (VPN) or an Intranet. The network 258 can include both wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 104, 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared, as needed.

The present invention relates to a method of operating the described enterprise system 200 for interacting with a corresponding user 110 when accessing a mobile banking platform via use of an associated user device 104, 106, wherein the mobile banking platform is associated with and/or managed by the enterprise system 200, and more specifically, the computing system 206 thereof. As utilized hereinafter, the user device 104, 106 may alternatively be referred to more generally as a transceiver by virtue of the manner in which the corresponding user device 104, 106 sends and receives communication signals, and the computing system 206 may also alternatively be referred to as the system transceiver by virtue of the manner in which the computing system 206 sends and receives communication signals with respect to the enterprise system 200. The mobile banking platform generally refers to a platform that is accessible to the user 110 via the user device 104, 106 when having an appropriate network connection to the enterprise system 200 and potentially any third-party external systems 202, 204 that are necessary for carrying out the system and method described herein via any form or number of associated networks 258. The user 110 may access the mobile banking platform via the corresponding user device 104, 106 for access to the data regarding the user 110 as maintained by the enterprise system 200, and for accessing any products and/or services offered to the user 110 via the enterprise system 200 and/or any third-party external systems 202, 204. The mobile banking platform may be representative of the previously described software application 132 operable on the user device 104, 106, as one non-limiting example. As another example, in some circumstances the mobile banking platform may alternatively refer to a mobile banking website, wherein the user 110 may access the website via an appropriate browser software application operating on the corresponding user device 104, 106, wherein navigation of the mobile banking website provides the user 110 access to the same or similar data and/or functions as may be encountered when utilizing the above-described software application 132 acting as the mobile banking platform. The mobile banking platform may be referred to more generally hereinafter as the transceiver platform by virtue of the corresponding mobile banking software application and/or browser software application corresponding to execution of the mobile banking platform occurring on a transceiver corresponding to the described user device 104, 106.

The mobile banking platform is also described hereinafter as being “interacted with” by the user 110 during navigation thereof. It should be understood that such interactions may refer to any suitable actions of the user 110 capable as acting as an input to the corresponding user device 104, 106, such as a corresponding touch screen interaction, voice activated command, interaction with a connected device (joystick, keyboard, mouse, etc.), or the like, as the circumstances may warrant. Such interactions are generally understood to typically correspond to a selection of an identifiable area of the display of the mobile banking platform, such as those areas corresponding to a specific image, block of text, or other graphical representation, which in turn redirects the mobile banking platform to change the data instantaneously displayed to the user 110 via a reconfiguration of the corresponding graphical user interface, and/or causes the mobile banking platform to perform a function in accordance with the selected interactive area of the display. For example, navigation of the mobile banking platform may be executed on the mobile device 106 having the described display 140 acting as the graphical user interface thereof and the interactions with the display 140 may be associated with touching the display 140 at the position(s) of the described interactive areas.

As mentioned hereinabove, each of the users 110 described herein may be a person or entity acting as a customer or client of the enterprise system 200 that utilizes products and/or services from the enterprise system 200 as defined herein, and more specifically, the relationship present between the enterprise system 200 and a corresponding user 110 may include the user 110 having a payment card account with the enterprise system 200 wherein certain actions of the user 110 as the primary user or cardholder of the payment card account, certain actions of other users 110 acting as authorized users of the payment card account, certain actions of the enterprise system 200, and/or certain interactions between the enterprise system 200 and one or more of the users 110 may be monitored and recorded by the computing system 206 of the enterprise system 200. Such data of each of the users 110 of the enterprise system 200 may be in the form of the data 234 stored to the storage device 224 of the computing system 206 as utilized for carrying out the functions of the mobile banking platform as described herein. The data 234 may originate from various different sources including the recorded interactions of each of the users 110 with the enterprise system 200 and/or the recorded interactions of each of the users 110 with one or more third-party and external sources or systems, which may be representative of the previously disclosed external systems 202, 204.

The payment card account of each corresponding user 110 may be associated with an umbrella account of the user 110 from which data corresponding to various additional or subaccounts is accessible during navigation of the mobile banking platform. For example, upon providing the necessary login credentials to access the corresponding umbrella account via the mobile banking platform, the logged-in user 110 may then be able to access each of a variety of different financial accounts or subaccounts maintained by the enterprise system 200 and associated with the user 110, including one or more such payment card accounts. Each transaction occurring with respect to a payment card account may be associated with certain data, such as a corresponding monetary amount, an entity to or from which funds were transferred or received as a condition of a transaction, a time stamp at which a corresponding transaction occurs, a category of the transaction, and/or a geographic location at which such a transaction has occurred or has otherwise been initiated by the corresponding user 110, by which such transactions may be appropriately categorized or sorted.

The examples provided hereinafter generally correspond to the types of transactions that would be expected to occur when managing a payment card account associated with a corresponding payment card, such as a debit card and/or a credit card, wherein various purchases, payments, and transfers of funds are typically monitored and recorded in some form when managing such a payment card account. However, it should be readily apparent that the same general concepts described herein may be applied to alternative financial accounts utilizing the monitoring of transactions occurring with respect to an alternative form of payment card or payment device while remaining within the scope of the present invention. For example, the payment card account may alternatively be associated with a temporary gift card or the like having a similar functionality to such a debit card or credit card, as one additional non-limiting example.

The presently disclosed system and method may be specifically applied to those payment card accounts of the enterprise system 200 that are associated with more than one person or entity that is identified or designated as having permissions to access and utilize the payment card account via the use of one or more corresponding payment cards or alternative payment devices (such as use of the mobile device 106 having digital wallet/mobile payment capabilities). Such individuals or entities having access to utilize such a payment card or device may be divided into primary account users and secondary account users, which may alternatively or interchangeably be referred to as primary cardholders and secondary cardholders hereinafter. Each primary account user may be an individual or entity having a direct contractual relationship with the enterprise system 200 with respect to the corresponding payment card, whereas each secondary account user may be an individual or entity that is designated by the primary account user(s) as having certain privileges or capabilities in utilizing the corresponding payment card to conduct transactions and/or in accessing other related features of the mobile banking platform relating to the corresponding payment card and payment card account, such as reviewing data regarding past transactions occurring with respect to the corresponding payment card account during navigation of the mobile banking platform. Each primary account user may be an individual or entity that establishes the user account with the enterprise system 200 and that is liable for actions occurring with respect to the corresponding payment card as a result of the direct contractual relationship present between such an individual/entity and the enterprise system 200. In some circumstances, it is conceivable that two or more individuals or entities may be considered to be such a primary account user with respect to the payment card account, such as when the payment card account is a joint account having two or more co-signers to an agreement regarding use of the payment card account, although for brevity and simplicity in describing the disclosed system and methodology the examples described hereinafter typically refer to only a single primary account user associated with one or more secondary account users acting as authorized users.

The payment card mentioned in the present examples may alternatively be referred to as an interactive device or payment device associated with the payment card account, wherein the interactive device or payment device may be provided in the form of a physical/tangible payment card or in the form of a digital wallet/mobile payment feature or the like as available via use of an appropriate user device 104, 106 having payment card information stored thereto and accessible for making such transactions via a corresponding function or feature of the user device 104, 106.

Depending on the circumstances and/or the terms and conditions of the associated payment card account, the various different payment cards associated with the payment card account may in some circumstances be provided to each of the secondary account users to include the same identifying information associated therewith such as having each of the same cardholder name, the same card number, the same expiration date, and the same card verification value (CVV) or other security based identifier associated therewith and visually accessible when inspecting such a payment card. The commonality of such information may lead to circumstances wherein it is not readily apparent which of the cardholders/users associated with the payment card account are actually initiating a transaction that occurs with respect to the payment card account, such as when all such identifying information is common to the payment cards of multiple such cardholders/users and the transaction in question is occurring via a process such as manually entering the necessary payment card information via a web-based or software application-based payment feature associated with online shopping, or the like.

However, it is also conceivable that the use of common identifying information as presented visually on each of the (tangible) payment cards may still allow for differentiation of such users/payment cards via data that is associated with each payment card while not being readily apparent during visual inspection thereof, such as the computing system 206 being aware of differentiating information regarding each respective payment card as may be stored to the magnetic stripe or chip associated therewith. Another example where common identifying information may still allow for differentiation of the users/cardholders of the payment card account may include where information or data that is associated with identifying the user device 104, 106 that is initiating such a transaction, whether via a digital/online purchase or the use of the digital wallet/mobile payment feature of the user device 104, 106 (or equivalents thereto), is known by or accessible to the computing system 206 such that each such transaction occurring via use of such a respective user device 104, 106 (as the payment device) may be associated, by the computing system 206, with the transaction being initiated by the user/cardholder known to utilize or be registered to the user device 104, 106 in question. That is, the computing system 206 may store data corresponding to which user/cardholder typically utilizes which user device 104, 106 in making such transactions with respect to the payment card account such that it can be assumed that transactions originating from each respective user device 104, 106 is associated with a specific one of the plurality of the users/cardholders. One example may include where one (or more) of the users/cardholders, such as the primary account user responsible for the payment card account, provides information to the computing system 206 regarding which user devices 104, 106 having performed transactions with respect to the payment card account is/are to be assigned to or otherwise associated with each of the users/cardholders associated with the payment card account. Another example may include wherein the computing system 206 prompts each such user/cardholder to confirm and/or provide information regarding their identity whenever a new user device 104, 106 is associated with completing such a transaction, wherein such prompting may occur via short message service (SMS, alternatively “text message”), push notification, or during proactive access to the mobile banking platform. Yet another example of differentiation may include where each user/cardholder is identifiable via knowledge of the respective digital wallet/mobile payment feature that is utilized in performing such a transaction, wherein each such user/cardholder is associated with a distinct digital wallet/mobile payment account having distinct identifying information accessible to the computing system 206.

Alternatively, each of the payment cards or payment devices associated with the payment card account may be provided to include at least one differentiable identifier for easily allowing the computing system 206 to determine which of the users/cardholders is responsible for a specific transaction, such as at least one of the name, the number, the expiration date, or the CVV differing among such payment cards associated with the common payment card account, among other differentiating information that may additionally be associated with each such a payment card or payment device. Such a circumstance leads to the computing system 206 easily determining which of the users/cardholders is responsible for initiating such a transaction regardless of the manner in which such a transaction is initiated as such differentiating information is generally associated with each such transaction as may be monitored and recorded by the computing system 206.

The presently disclosed system and method beneficially includes a security feature wherein information relating to each transaction occurring with respect to the shared payment card account is reported, in real-time, to one or more of the users/cardholders thereof for identifying unusual or unexpected relationships or circumstances. Specifically, such information may preferably include information relating to the geographical location at which each such transaction occurred and/or was initiated by an action of one of the account users of the payment card account, as may be most accurately determined by the computing system 206 in accordance with the various methodologies suitable for monitoring and reporting such transactions as outlined herein. That is, certain forms of transactions may potentially include the use of different methodologies in attempting to determine the geographical location associated with the process of conducting and/or initiating such a transaction in accordance with the information that may be derived from the methodology utilized. Each of the users/cardholders that receives such information via the reporting of the computing system 206 is assumed hereinafter to be the primary account user (or one or all of the primary account users where multiple associated account users are so designated) of the payment card account such that the primary account user is able to monitor the transactions of one or more secondary account users (and potentially those of other primary account users, as permitted), thereby allowing for the primary account user to have the ability to determine when potentially unauthorized or fraudulent transactions are occurring with respect to any such authorized users via review of the information communicated with respect to each such transaction. In addition to determining the geographic location of the corresponding account user at the time stamp associated with each such transaction, the system and method disclosed herein may also conceivably monitor and report any information relating to the geographical location of the recipient of any payments or transfers of funds as may occur with respect to the payment card account, as applicable.

Various forms of transactions that may be monitored and/or reported according to the present system and method may require that certain permissions or approvals be given by each such user/cardholder in accordance with the respective privacy and/or security concerns thereof. Such permissions or approvals may be provided for selection by each respective user/cardholder during navigation of the mobile banking platform on a corresponding user device 104, 106, and may include each respective user/cardholder selecting certain settings corresponding to what actions are to be taken by the computing system 206 with respect to certain circumstances that may arise when transactions are conducted or initiated with respect to the shared payment card account. Such settings may include each such user/cardholder indicating which forms of information associated with each transaction are permissible to be communicated to the computing system 206 for recordation thereof, as well as which forms of such communicated information are then permitted to be communicated from the computing system 206 to the user device 104, 106 of the designated primary account user in accordance with the presently disclosed system and method. Specifically, the communication of information that may relate to the privacy and/or security of the user/cardholder associated with each such transaction may require such additional permissions or approvals from the corresponding user/cardholder, with specific reference to information relating to the instantaneous geographic location of each such user/cardholder when conducting or initiating such a transaction.

In some circumstances, it may be conceivable that the primary account user may unilaterally have the capability to select certain settings with respect to at least some circumstances and/or the monitoring/reporting of at least some forms of information that would otherwise require receipt of permission of the respective secondary user/cardholder under contrary circumstances. For example, many such payment card accounts having multiple authorized users may include a primary family member, such as a parent or other authority figure as primary account user, permitting multiple secondary family members to be designated as authorized secondary account users, such as the children of the primary family member. Such a circumstance may allow the primary account user to permit the secondary account users to utilize the payment card account in various ways while the primary account user maintains control over the settings associated with the level of privacy afforded to each such secondary account user, and especially where such secondary account users are minors for which the primary account user is responsible and thus appropriately capable of making such determinations on the behalf of each such secondary account user. As another example, an individual acting as a representative of a business entity, such as an owner, manager, or supervisor thereof, may act as the primary account user, and any employees or other agents of the business entity under the supervision of the primary account user may thus act as the secondary account users. Again, such a circumstance may render it appropriate for the primary account user to make determinations regarding the information that may be monitored or reported with respect to each such secondary account user in managing the activities of such employees or agents of the business entity when utilizing the payment card account.

The manner in which such geographic information is derived by the computing system 206 may also lead to different capabilities of the primary account user in determining the settings of such secondary account users. For example, the primary account user may have the ability to unilaterally determine whether or not information relating to the geographic location of a point-of-sale (POS) card reader or equivalent at which a transaction has occurred or been initiated via an in-person payment method (such as an in-person card swipe or an in-person use of a digital wallet/mobile payment feature or equivalent thereof) is to be recorded and reported by the computing system 206 with respect to each (secondary) account user because such information may be derived from the process of the POS card reader communicating back-and-forth with external systems, such as the computing system 206, during the process of authorizing and completing such an in-person transaction, thereby posing no additional risk of an invasion of privacy of the secondary account users beyond existing and documented methods of tracking such purchases. In contrast, the primary account user may not have the ability to unilaterally determine whether or not information relating to the geographic location at which a transaction is conducted or initiated is to be monitored and reported to the primary account user where such a determination is based exclusively on tracking the precise geographical location of the user device 104, 106 of the corresponding one of the secondary account users responsible for such a transaction. That is, additional permissions may be required to be given by each such secondary account user when information regarding the instantaneous location of the user device 104, 106 is necessary in determining the geographical location of the transaction, such as when the secondary account user is not conducting or initiating a transaction at a card reader associated with a POS where the geographical location may normally be derived from the process of the card reader communicating with external systems for authorizing and finalizing the transaction in question.

The selectable settings regarding the monitoring and reporting of transaction information may include each account user specifying whether permission is granted to the computing system 206 for tracking the instantaneous location of the user device 104, 106 associated with each such account user in order for certain types of transactions to be monitored and reported that otherwise may not be captured by traditional methods such as those described above with reference to an in-person payment via a card reader at a POS. Each such account user may further be able to determine whether such approval of location sharing of the corresponding user device 104, 106 with the computing system 206 further corresponds to approval to forward transaction related information to each designated primary account user. Such permissions may be given broadly with respect to all possible tracking methodologies or may be narrowly tailored and associated with each distinct methodology of performing the tracking of such a user device 104, 106, such as providing individual selections with respect to each of location sharing via a GPS-based system, location sharing via cellular service, or location sharing via the use of an IP address.

The instantaneous location determined with respect to each associated user device 104, 106 of one of the secondary account users having previously given permission (where applicable) for location sharing may preferably be based on the positioning device 108 of each associated user device 104, 106 being the previously described GPS transceiver as is most commonly found in the implementation of the user device 104, 106 as the mobile device 106. Alternatively, the above-mentioned cellular service based methodology may rely upon the triangulation of cellular signals to identify the approximate location of the associated user device 104, 106 where cellular service is accessible via the corresponding device 104, 106, which may once again be more commonly found in the implementation of the user device 104, 106 as the mobile device 106. As a final example, the IP address based methodology may include the computing system 206 monitoring and recording the geographic location associated with the IP address at which a corresponding user device 104, 106 accesses any necessary networks 258 during the process of conducting a digital or online transaction, although such a method is generally less reliable in accessing the precise location of the corresponding user device 104, 106 with respect to certain circumstances. For example, it is known that different internet service providers utilize different methodologies of assigning IP addresses and/or of updating publicly available resources regarding the geographic location associated with certain IP addresses following a change thereto, which can significantly alter the reliability of such IP address based geographic location determining processes. It is also known that different wireless networks broadcast different signals and/or information than others in a manner rendering the geolocation of certain IP addresses as more precise, accurate, or reliable in comparison to others, such as certain Wi-Fi access points broadcasting data in addition to the IP address of the associated network that can be used to improve the accuracy of the geolocation of the Wi-Fi network, such as broadcasting the GPS-based location of one or more mobile devices 106 in signal communication with the Wi-Fi network, thereby improving the accuracy and precision of the use of an IP address to that approaching the direct use of a GPS transceiver of an associated mobile device 106. The use of the GPS transceiver may thus be the preferable form of the positioning device 108 associated with each user device 104, 106 when implementing the present invention due to the accuracy and precision thereof in comparison to the other described methods.

Due to the lack of precise/accurate location tracking often associated therewith, the use of cellular triangulation or the tracking of the geolocation of an IP address as the location monitoring methodology may also result in the need to assign a nominal location to a corresponding user device 104, 106 relying on such methodologies. For example, if the user device 104, 106 of an account user is determined to be within a certain geographic boundary without the ability to determine a more specific location of the recipient therein (such as being unable to determine the GPS coordinates thereof), then the location of the corresponding user device 104, 106 may be associated with a nominal point position representing the geographic boundary within which the user device 104, 106 is located, such as a central point or predetermined relevant point associated with the boundary of an associated city, as one non-limiting example. In some circumstances, the nominal point may be based on a geographic location that is associated in some way with the internet service provider utilized by the one of the user devices 104, 106 for which a location is being determined, such as the reported location of the IP address of the user device 104, 106 being that of a facility or network of the internet service provider that is common to a plurality of different user devices 104, 106 routing information via such an internet service provider. It may be assumed hereinafter that the present invention utilizes what is considered to be the most reliable, and/or accurate, and/or precise methodology that is available and permitted with respect to each associated user device 104, 106 for making the determinations described herein, where possible or consistent with the type of transaction occurring.

The computing system 206 may be capable of utilizing multiple of the above-described methodologies in conjunction for confirming the accuracy of the determined location of the corresponding transaction with respect to any one of the described methodologies. That is, where the necessary permissions are provided by the corresponding account user for use of all associated methodologies, the computing system 206 may evaluate the accuracy of the geographic location determined by a primary methodology and/or may replace the geographic location determined by a primary methodology by comparing the geographic location as determined via the primary methodology to the geographic location as determined via a secondary methodology, wherein the secondary methodology may be generally considered to be more precise, accurate, and/or reliable than the primary methodology. For example, the primary methodology may correspond to the use of the geolocation indicated as being associated with the IP address or other routing information as may be generated via the transaction occurring with respect to a card reader at a corresponding POS or may correspond to the use of the geolocation indicated as being associated with the IP address associated with the corresponding user device 104, 106 when connected to a local network 258 and performing an online or digital purchase, each of which may potentially provide unreliable or imprecise results. In such an example, the secondary methodology may include the computing system 206 monitoring and recording the geographic location of the user device 104, 106 known to the computing system 206 as being associated with the secondary account user having conducted the transaction in question via use of the GPS transceiver thereof.

If the determined geographic locations match each other within some predetermined first tolerance or distance value, then the computing system 206 may associate the corresponding transaction with either of the determined geographic locations without compromising the accuracy of the information communicated to the primary account user. In contrast, if the determined geographic locations differ from each other to an extent beyond the predetermined first tolerance or distance value, then the computing system 206 may choose to utilize the determination made via the generally more reliable secondary methodology. As yet another potential circumstance, the discovery of the computing system 206 of a significant difference between the two determinations, such as the difference exceeding a second predetermined tolerance or distance value greater than the first tolerance or distance value, may result in the computing system 206 also considering such a significant difference as potentially being indicative of a fraudulent or unauthorized purchase that should be flagged as such when communicating the determined geographic location of the transaction to the primary account user.

The primary account user to which such information is generally communicated may also have access to selectable settings regarding which forms of the information are to be communicated in any form of message or notification that is sent to the user device 104, 106 of the primary account user each time a transaction occurs, such as filtering whether somewhat optional information, such as the category of the corresponding transaction, should be included in the communication or notification. Additional settings regarding optional information may include the communication or notification including information relating to the balance of the payment card account following the transaction in question or any information that is available regarding the vendor or recipient of the funds of the transaction in addition to the geographic location thereof, such as a web address, street address, or the like thereof where such information is known to the computing system 206.

The primary account user may also select other circumstances, such as by associated settings as may be established during navigation of the mobile banking platform, under which a transaction may be flagged by the computing system 206 such that additional attention should be provided thereto by the primary account user upon receipt of a communication from the computing system 206 regarding the conducting or initiating of the corresponding transaction. As noted above, one such setting may correspond to the primary account user choosing whether to flag those transactions where the determined geographic location of the transaction in question via the primary methodology does not align with the determined geographic location of the user device 104, 106 of the secondary account user via the second methodology within certain predefined ranges of distance values, as may be indicative of the payment card and the secondary account user associated with the user device 104, 106 being separated from one another in a suspicious manner. Another possible setting selection may include the primary account user having the ability to choose whether certain characteristics of the transaction in question meet certain criteria, such as flagging any transactions that do or do not fall within a predefined range of possible monetary values, such as flagging any transaction that exceeds $100, $200, $500, $1000, and so on, as non-limiting examples, wherein such ranges of values associated with such flagging may be preset selections or may be directly entered by the primary account user. The primary account user may also be able to choose to flag any transactions that are determined to establish a troubling trend or cumulative effect with respect to a plurality of such transactions, such as flagging each transaction that occurs beyond a set number of such transactions within a predefined range of time, such as within an hour, a day, a week, and so on, or alternatively any cumulative transactions occurring within such a time period adding up to a total amount that exceeds a monetary value not to be exceeded within such a time period. The primary account user may also be able to select geographic limits on which transactions are to be flagged, such as flagging any transactions that are determined to fall within or outside of any predefined geographic boundaries, such as any transactions determined to have occurred inside and/or outside of, depending on the circumstances, one or more selected boundaries associated with one or more corresponding cities (municipalities), counties, states, countries, continents, zip codes, or area codes, or combinations thereof. Lastly, it may be conceivable that the primary account user may be able to select settings indicating that a transaction occurring with respect to one or more preselected business entities or equivalents are to be flagged as being unapproved by the primary account user. Such selectable settings may include the ability to combine any of the factors described above, such as flagging those transactions that both fall within a certain monetary range while also being located within/outside a certain geographic boundary, as desired.

Thus far, the geographic location of each such transaction has been described only in the context of the reporting of the geographic location at which the transaction was conducted or initiated, but the present system and method may also include the computing system 206 being able to determine and communicate information relating to the geographic location of any such transactions initiated by a secondary account user relative to another geographic location for establishing a relationship therebetween. The geographic location that is compared to that determined with respect to transactions originating from one of the secondary account users may be a predefined and fixed geographic location as established by the primary account user, such as the geographic location of a home or business facility of the primary account user, or may be a variable geographic location based on the instantaneous geographic location of the primary account user as determined by referencing the geographic location of the user device 104, 106 thereof. As described above, the flagging of such transactions may be based on whether the determined distance between the two geographic locations falls within or exceeds a set distance value or range of distance values, such as a relative distance of more than 25 miles, 50 miles, 100 miles, and so on being present between the two determined geographic locations. In the case of comparing the geographic location of the user device 104, 106 of the primary account user to the geographic location of a corresponding transaction, the primary account user would also be required to provide the necessary permissions to the computing system 206 regarding location sharing and/or reporting of the geographic location of the user device 104, 106 of the primary account user to allow for such a comparison to be made in accordance with the disclosed system and method.

The use of a comparison of the geographic location of the primary account user to that associated with a transaction conducted or initiated by one of the secondary account users may be associated with various additional selectable settings establishing whether certain transactions are to be flagged when communicating such information to the primary account user. As one additional example, the computing system 206 may determine whether the geographic location of the user device 104, 106 of the primary account user and the geographic location of a corresponding transaction of a secondary account user are or are not located within a common geographic boundary, such as both the determined locations being located within the same city, county, state, country, continent, zip code, area code, or combinations thereof, as non-limiting examples of geographic commonalities or dissimilarities. The selectable settings provided to the primary account user with respect to such a feature may include the primary account user selecting what form of geographic boundary to refer to (city, state, country, etc.) and what conditions (being within or outside of the same boundary) result in a flagging of a transaction. The use of a comparison of the geographic location of the primary account user (specifically, user device 104, 106 thereof) and the transactions of the secondary account user(s) provides a useful security function when the authorized users of the shared payment card account are traveling or otherwise coordinating their movements, as possibly fraudulent or suspicious activities may be able to be more accurately assessed in view of the relationship present between the primary account user and the secondary account user(s), such as not flagging those transactions occurring at a geographic location that would otherwise appear suspicious if not for all such account users being in close proximity to each other.

Any information relating to any relationship present between the geographic location of the primary account user and any transaction of a secondary account user may also, in addition to setting a condition for flagging such a transaction, be reported as a part of the information that is included in the communication sent by the computing system 206 to the primary account user. That is, the determined location associated with the reported transaction may be presented in conjunction with information relating to the relationship present between the transaction and the primary account user. Where such relationship information is presented, the primary account user may select settings regarding how such relationships are described or presented in the reporting communication, such as allowing the primary account user to select to utilize a relatively exact relative distance value (such as a distance represented as the number of miles present between the geographic locations to the whole mile, half mile, quarter mile, or tenth of mile, depending on the desired resolution), or whether to select to utilize different ranges of distance values such as choosing to utilize 5 mile increments (within 5 miles, 5-10 miles away, 15 miles away, etc.), 10 mile increments, 25 mile increments, and so on, or choosing whether the different ranges of distances are reported numerically or via description (such as reporting that the compared geographic locations are in “close proximity” to each other or “at a great distance” from each other). If the relationship information relates to commonalities or dissimilarities between the determined locations with respect to a geographic boundary (city, state, country, etc.), then the primary account user may again be provided the selectable setting of whether and how this relationship information is reported in the corresponding transaction communication, such as indicating which common or dissimilar boundaries are to be mentioned in the communication, such as limiting such reporting to whether the compared geographic locations are within the same city or state, but not mentioning whether they are in the same country or continent.

All of the different conditions described herein as being associated with the potential flagging of a transaction may also be directly associated with the computing system 206 determining that a transaction is somehow fraudulent, unauthorized, or otherwise suspicious in a manner resulting in the computing system 206 proactively suspending use of the associated secondary payment card or credentials thereto until further action is taken by the primary account user in indicating that the transaction(s) in question are not indicative of such fraudulent activities, or suspending all such activities associated with any of the payment cards or payment devices associated with the shared payment card account. The communication sent to the primary account user reporting such a transaction that has been designated as being fraudulent such that the suspending of activities regarding the payment card account are necessary in some form may accordingly include information or some form of link or associated redirecting means for guiding the primary account user to resolve such a concern, whether via access to the mobile banking platform or via establishing a chat session or phone call with an agent 210 of the enterprise system 200 for resolving such an issue, such as returning the payment card account back to normal operation via confirmation that no fraudulent or suspicious transactions have taken place despite a certain condition being met that indicated the likelihood of such a circumstance.

In the same manner, any communication relating to a flagged transaction that does not result in a suspending or alteration of use of the payment card account may similarly be provided along with information regarding the primary account holder taking action to suspend or alter such use of the payment card account or taking action to report the suspicious nature of the transaction to the enterprise system 200 for further investigation or consideration, such as once again providing a link, redirecting means, or the like for directing the primary account user to the mobile banking platform and/or an agent 210 of the enterprise system 200 having the ability to handle such circumstances. The primary account user may be able to select which circumstances lead to such actions being taken by the computing system 206 as selectable settings in the same manner as described above with respect to selecting the circumstances leading to the flagging of such transactions, wherein the primary account user may designate different circumstances as merely leading to the flagging of the transaction or leading to the suspension of payment card account activities, as desired.

The communication sent to the primary account user(s) upon each payment card or payment device use may take on a variety of different forms while remaining within the scope of the present invention. Such a communication reporting the transaction related information may be sent to the user device 104, 106 of the primary account user according to the use of a push notification associated with execution of the mobile banking platform on the user device 104, 106 in question, the use of a short message service (SMS, referring to text messages) associated with the user device 104, 106 (typically associated with a specific phone number assigned to a mobile device 106), or the use of an email account of the primary account user that is accessible via the user device 104, 106 and capable of providing real-time updating of the primary account user (such as the email program being used itself sending a push notification upon receipt of a new email). The primary account user may once again be presented with selectable settings relating to which of the forms of the communications are to be utilized by the computing system 206 in accordance with the desires of the individual primary account user.

The communication sent by the computing system 206 may include any subset or combination of any of the transaction related information therein in accordance with the different selectable settings or different embodiments of the invention as proposed herein, and may typically include only limited information among all possible information available for summarizing the transaction in a way that communicates the necessary information succinctly and directly without introducing confusion or complexity. For example, the initial push notification, SMS message, or email sent to the primary account user by the computing system 206 may include limited information among all available reportable information while also providing a means to access additional available information via further interaction with the communication in some form, such as providing a link or redirection means in the communication to redirect the user device 104, 106 receiving the communication to another page, website, or feature associated with the mobile banking platform or an associated web browser where additional information can more easily be communicated in its entirety or can be more easily navigated via a different interface than is typically available when utilizing basic text messaging, push notification, or email functionalities. For example, the communication may only report very limited information in the content thereof such as which cardholder initiated the transaction (which may include reference to the name on the payment card in question, a name assigned to the user device 104, 106 utilized in conducting the transaction, a unique card number among multiple issued payment cards, etc.), the amount of the transaction having occurred (including whether funds were reduced via a purchase or increased via a refund, payment on a balance, etc.), and the last four digits of the payment card utilized. The communication may further include a uniform resource locator (URL) for redirecting a web browser to a specific webpage of website or a deep link for redirecting to a specific aspect of the mobile banking platform. Once so redirected, all relevant information regarding the transaction may then be available to the primary account user for making any further determinations.

It is also conceivable that information related to the geographic location of the transaction may be communicated in such an initial communication in some form, including listing general information such as the city and state identified as the location of the transaction, providing information relating to whether the determined location of the transaction meets any of the conditions described herein (such as indicating in the communication that the transaction occurred in an approved or unapproved manner according to the examples provided herein) as flagging or not flagging the transaction as suspect, listing or otherwise indicating that additional geographic location information may be retrieved via redirection to a website and/or software application associated with the mobile banking platform via the text of the communication or illustration of a symbol, icon, or the like indicating such a feature, or even providing relatively specific information regarding the location of the transaction, such as providing a relatively small map image showing the location of the transaction, an address associated with the location of the transaction, or coordinates associated with the location of the transaction, as non-limiting examples.

Depending on the form of communication utilized, specific forms of interaction by the primary account user with the user device 104, 106 regarding the communication may result in additional information, including the geographic location related information, being presented to the primary account user via the user device 104, 106 in accordance with such an interaction. For example, where a push notification is provided, the specific form of interaction leading to additional or different information being provided may include maintaining contact with an interactive area presented on the display 140 of the user device 104, 106 until redirected to the additional or different information, such as pressing and maintaining contact with an interactive area presented on a touch screen display or utilizing a click-and-hold interaction with an interactive area via use of a mouse or similar device until a redirection occurs, or other interactions such as multiple touches or clicks in multiple succession, or equivalents to such processes. Such a specific interaction may lead to an image such as a map image being presented on the display 140 of the user device 104, 106 or may lead to enlargement of an image (map) already shown in the communication in a relatively smaller or less easily readable format.

It should be noted that any of the settings set forth herein as being selected by one of the primary account users may not in all circumstances be selectable or otherwise associated with a determination made by the primary account user, and may instead be representative of different embodiments of the present invention where each such selection is instead the default setting or option that is predetermined to be utilized by the disclosed system and method. That is, the present invention may be limited to any given set of the features described herein while remaining within the scope of the present invention, such as the system and method reporting only a subset of the information described herein as possibly being communicated to the primary account user or only using a subset of the methodologies described herein as being suitable in determining the geographic location of one of the account users in the absence of the ability to utilize different or additional information or methodologies according to those settings or selections as made by the primary account user. The disclosed examples relating to the described listing of all possible selectable settings may thus be considered to be representative of the most diverse and comprehensive embodiment of the present invention providing the most customization and influence by each of the primary account users, although such variability of options is not necessary is achieving the objectives of the present invention so long as each of the primary account users designated as receiving the types of communications described herein is provided enough information in a manner facilitating an improvement in the ability of each of the primary account users to determine whether any such transactions are problematic or otherwise indicative of theft, fraud, or unauthorized activities.

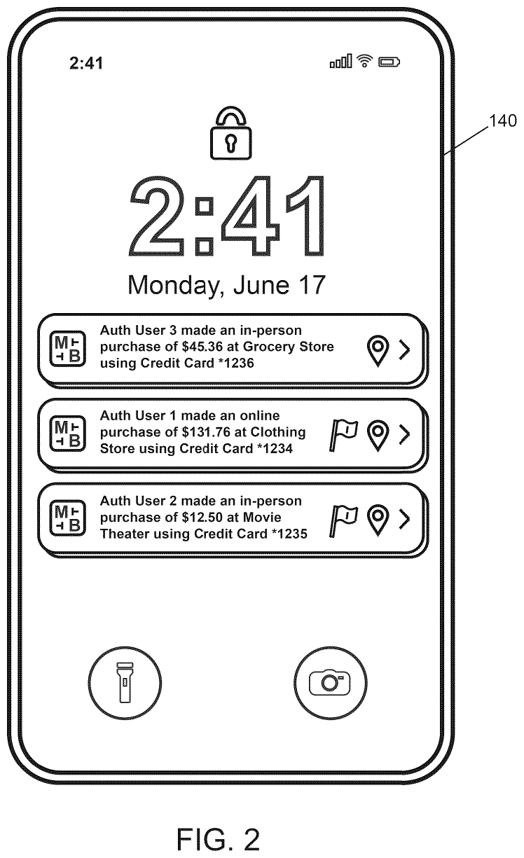

Referring now to FIGS. 2-5, representative and non-limiting visual examples of such communications are disclosed for illustrating the basic concepts of the present invention as set forth hereinabove. FIGS. 2-5 show examples of the receipt of push notifications to a user device 106 of a primary account user relating to transactions having occurred with respect to secondary account users of a shared payment card account. It should be readily apparent to one skilled in the art that similar information may be presented and/or similar interactions may occur with respect to SMS messages, emails, or the like consistent with the illustrated examples shown with respect to such push notifications, hence such alternative forms of communication need not be shown to understand the novel features of the present invention.

Each of the examples refer to the corresponding secondary account users by generalized names including “Auth User 1,” “Auth User 2,” and “Auth User 3,” which may normally be presented as the actual name of the cardholder or some other identifying information, such as the name of the user device 104, 106 initiating the transaction. The shared payment card account is also indicated as utilizing slight variations of each payment card assigned to each secondary account user according to one possible set-up of such a shared payment card account, but as mentioned above some such shared accounts may share such certain aspects such as the card number among all such payment cards. Each push notification is shown as communicating the source of the notification with “MB” representing the mobile banking platform of the enterprise system 200, the name/identity of the secondary account user associated with each reported transaction, whether the transaction occurred in-person or via online shopping, the amount of the transaction, the recipient of the funds of the transaction, and the payment card number associated with each transaction. In the provided examples, the short text of the communication does not include information relating to the geographic location of the transaction, but does show a pin or map marker icon or symbol for notifying the communication recipient that geographic location information is available and retrievable via interaction with the push notification, such as clicking on the right facing arrow next to such a pin or map marker icon or symbol. Two of the transactions are also shown alongside a flag icon or symbol representative of some form of unusual circumstance indicative of fraud or unauthorized use having occurred with respect to the identified transactions, which may similarly be accessed via clicking on the right facing arrow. As mentioned above, such information may alternatively be accessed by clicking and holding on the message or some other equivalent interaction assigned to the retrieval of such additional information.

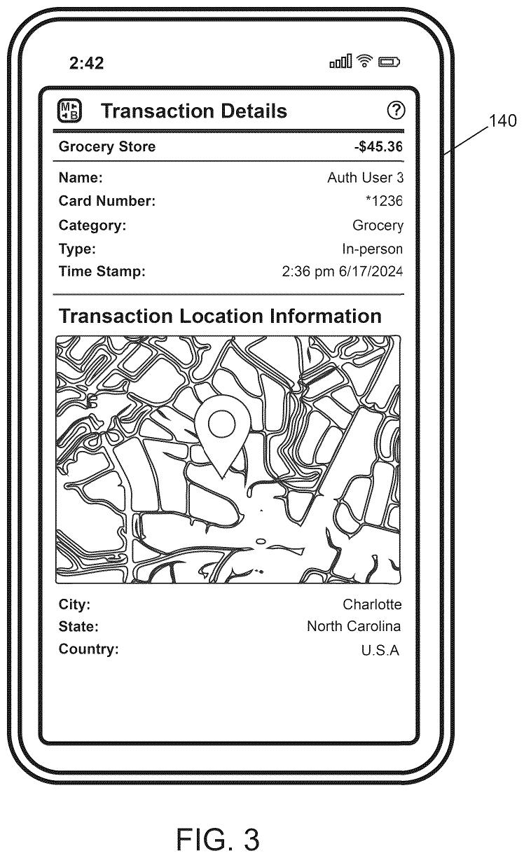

FIG. 3 shows the additional information that may be presented to the primary account user upon appropriate interaction with the top arranged push notification having additional geographic information available that has not met any conditions relating to a flagging of the transaction, wherein such a screen display may be associated with a URL or a deep link to the mobile banking platform. The additional information relating to the transaction in question (and not presented in the text of the push notification) includes a category of the transaction (grocery), a specific time stamp for the transaction, and the information relating to the geographic location of the transaction. In the present example, an image of a map of the area surrounding the transaction is shown with a pin or marker showing the specific location of the transaction (which is centered on the map image). The present example also includes location information in addition to the map image including the city, state, and country in which the transaction occurred. It is conceivable that selection of the map image may redirect the primary account user to an additional software application or to a plug-in of the mobile banking platform for reviewing the geographic location presented on the map image, such as zooming in, zooming out, or translating the map image to show different mapped areas.

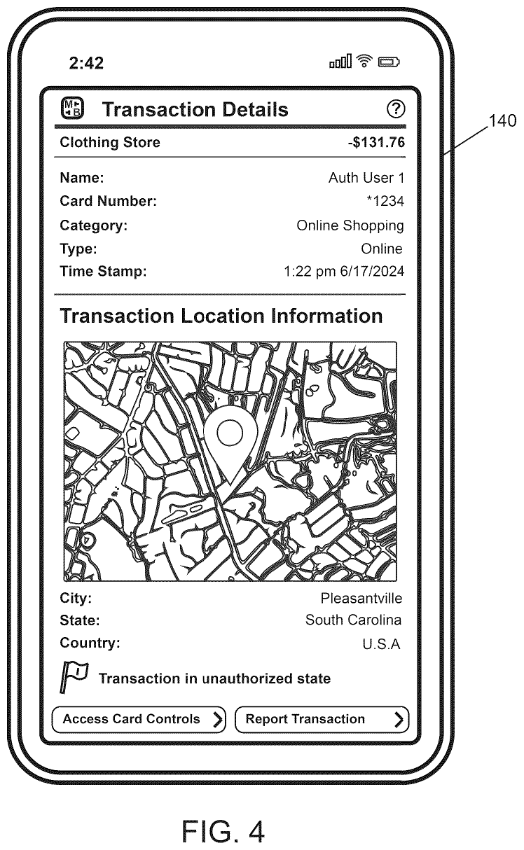

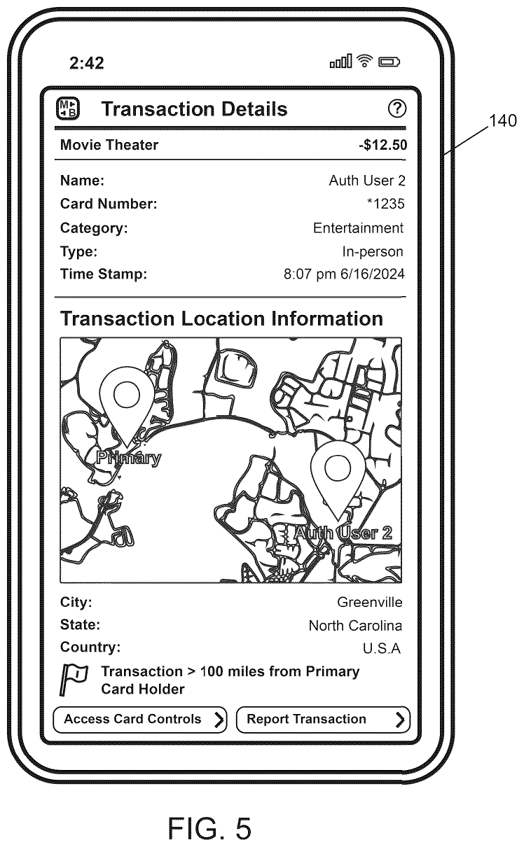

FIGS. 4 and 5 include the display of the same basic forms of information, but also include graphics indicating that the transaction has been flagged as suspect along with interactive areas that may be interacted with to redirect the user device 104, 106 to appropriate aspects or interfaces of the mobile banking platform for accessing card controls, reporting the transaction to the enterprise system 200 for further review or consideration, and/or for confirming the suspect nature of the transaction by the primary account user in accordance with the flagging of the transaction. The access to the card controls may relate to the ability of the primary account user to suspend or alter subsequent use of the corresponding payment card account, including the ability to cancel or suspend subsequent use of one or more of the payment cards associated with the shared account at the discretion of the primary account user and in reaction to the flagged condition. The reporting and/or confirmation of the suspect nature of the transaction by the primary account user may be utilized to contest the transaction, attain a refund regarding the transaction, or generally aid the computing system 206 in understanding suspect activities, as the circumstances may warrant. The actions taken by the computing system 206 when determining that such an anomalous (suspect) transaction has occurred when analyzing the information relating to the determined geographic location(s) and/or the actions taken by the computing system 206 upon further intervention by the primary account user in reporting or confirming the analysis of the computing system 206 accordingly results in the computing system 206 making significant improvements in the field of payment card account security with respect to any or all of securing the instantaneous transaction in question, securing subsequent transactions that may occur similarly with respect to the instantaneous shared payment card account, and securing the transactions of other users of other payment card accounts via the information gathered from the disclosed process that can be utilized in the future in more easily determining suspect or anomalous transactions under similarly occurring circumstances.

In FIG. 4, the flagged condition relates to the transaction occurring in a state that has not been designated as allowable in accordance with the preference of the primary account user or in accordance with default or standard processes followed by the enterprise system 200 in detecting fraudulent or suspect transactions. The determination made by the computing system 206 with respect to FIG. 4 requires only the geographic location of the transaction in question being known to the computing system 206 of the enterprise system 200, via whatever applicable methodology, and does not take into consideration any information relating to the geographic location of the primary account user as indicated by the geographic location of the user device 104, 106 of the primary account user at the time of the transaction.

In contrast, FIG. 5 illustrates a circumstance wherein the flagged condition is based on a relative position of the primary account user to that of the associated secondary account user in determining whether a fraudulent or suspect circumstance has occurred. As indicated in the text next to the flag icon or symbol, the condition in the present example relates to the primary account user and the secondary account user being more than 100 miles apart at the time of the transaction in question. The example of FIG. 5 accordingly includes a mapping of each of the geographic location of the primary account user and the geographic location at which the transaction in question occurred, thereby presenting a visualization of the relationship present between the two determined geographic locations for ease of understanding by the primary account user. However, the use of relative positioning in determining such flagged conditions may alternatively be associated with only mapping the geographic location of the transaction in question according to either of the examples shown in FIG. 3 or 4 while remaining within the scope of the present invention. In circumstances where the secondary account user is a child or dependent of the primary account user where such circumstances are not typical or expected, or where the secondary account user is an employee or agent of a business where activities should be restricted to certain geographic areas, such a comparison may reasonably represent a lost, stolen, or misappropriated use of the payment card in question, or potentially a stolen identity of the corresponding cardholder. On the other hand, where the primary account user and the secondary account user are traveling together, conducting business together in a new geographic area, or the like, it would be less likely for such a circumstance to occur, thereby avoiding unnecessary alerts or flags.

The disclosed reporting of information relating to the geographic location at which each transaction associated with a shared payment card occurs accordingly represents a dramatic improvement in the technical field of securing payment card related transactions via the ability of the primary account user to quickly and easily determine whether the circumstances associated with each reported transaction are suspect for any number of different reasons or via any number of different methodologies. The present invention utilizes the ability to determine the geographic location information regarding a transaction facilitated by an associated secondary account user, whether directed exclusively towards determining the geographic location of the user device 104, 106 of the associated secondary account user at the time of the transaction or whether directed towards determining a relationship present between the determined geographic location of the user device 104, 106 of the primary account user and the determined geographic location of the user device 104, 106 of the primary account user at the time of the transaction, in order to communicate relevant information to the primary account user as an additional security step allowing the primary account user to determine whether an unexpected or explicitly unapproved circumstance or condition has occurred.

The computing system 206 utilizes the technical features of each respective user device 104, 106 for determining such geographic location information in a manner that otherwise would not be able to be replicated in the absence of the ability of the computing system 206 to monitor and/or communicate with the respective user devices 104, 106 of each associated party in a real time manner. The present system and method thus presents a practical solution to situations where it is otherwise not possible for the primary account user to confirm the circumstances surrounding each such monitored transaction, and especially the circumstances relating to the instantaneous geographic location at which such a transaction is initiated or carried out in comparison to the geographic location of the associated secondary account user as known to the primary account user. For example, certain information reported to the primary account user may unambiguously indicate a problematic circumstance, such as the reporting of a transaction occurring out of the state or out of the country when such a situation is known to be impossible to the primary account user, such as when the primary account user (which may be acting as a parent, guardian, employer, etc.) can instantaneously confirm that the associated secondary account user (when acting as a child, dependent, employee, agent, etc.) is not located geographically at the determined location of a transaction. The ability of the system and method disclosed herein to also take proactive steps in addressing such a concern according to settings selected by the primary account user, such as flagging a transaction, automatically reporting a transaction as suspect, or providing an option for the primary account user to suspend or cancel use of an associated payment card, further emphasizes the practicality of the use of such a system and method. The manner in which such geographic location information is passed along to the primary account user in real time, which may include the use of various alert features of an associated user device 104, 106 to ensure the timely receipt of such information, prevents further fraud or other unauthorized uses as quickly as possible and often in ways that the enterprise system 200 alone could not determine based on the specific knowledge of the primary account user on what types of actions or circumstances to expect with respect to each associated secondary account user. The ability of the disclosed system and method to also cross-reference the determined geographic location of the user device 104, 106 of a secondary account user with the geographic location at which a transaction supposedly facilitated by the associated secondary account user occurred or was facilitated also adds an additional layer of security to the monitoring of each such transaction. Lastly, the ability to compare the determined locations of each of the primary account user and the associated secondary account user provides a new security feature wherein the relative positioning of such parties can be utilized in determining whether circumstances appear unusual or should be flagged in accordance with ever changing circumstances that may be faced by such parties, such as when traveling together where traditional methodologies may have been suspect of the activities of the associated secondary account user when considered in isolation, such as assuming that transactions carried out in new or unexpected locations necessarily points to theft or unauthorized use.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

1. A system transceiver for interaction with a first transceiver associated with a first user, the system transceiver comprising:
at least one processor;
a communication interface communicatively coupled to the at least one processor; and
a memory device storing executable code that, when executed, causes the processor to:
determine a first geographic location at which a data transfer is initiated during use of an interactive device associated with a second user, wherein the first geographic location is determined based on transaction-related data routing information;
determine a second geographic location at which the data transfer is initiated during use of the interactive device based on location information obtained from a positioning device associated with a second transceiver of the second user;
determine whether the first geographic location and the second geographic location differ by more than a predefined threshold;
designate the data transfer as a suspect transaction within the system transceiver in reaction to the first geographic location and the second geographic location differing by more than the predefined threshold;
automatically modify operation of the system transceiver in reaction to the data transfer being designated as a suspect transaction, the modified operation of the system transceiver corresponding to at least one of:
automatically suspending or restricting subsequent transaction activity associated with at least one of the interactive device or a payment card account associated with the interactive device, or
automatically altering a graphical user interface of the first transceiver associated with the first user to include an interactive area redirecting the first transceiver to an interface for suspending or restricting subsequent transaction activity associated with at least one of the interactive device or the payment card account associated with the interactive device.

2. The system transceiver of claim 1, wherein the payment card account is issued by a first entity managing the system transceiver, and wherein the data transfer relates to use of the interactive device to conduct a transaction relating to the payment card account.

3. The system transceiver of claim 2, wherein the payment card account is shared between the first user and the second user, wherein the first user is a primary account user of the payment card account that is directly legally responsible for the payment card account and wherein the second user is a secondary account user of the payment card account that is not directly legally responsible for the payment card account.

4. The system transceiver of claim 2, wherein the interactive device is at least one of a tangible payment card and/or a digital payment feature executable on the second transceiver associated with the second user.

5. The system transceiver of claim 2, wherein the transaction is one of an in-person transaction or an online transaction.

6. The system transceiver of claim 5, wherein, when the transaction is an in-person transaction, the first geographic location at which the data transfer was initiated during use of the interactive device is determined based on data routing information associated with the interactive device being scanned or read by an interactive device scanner or reader associated with a point-of-sale.

7. The system transceiver of claim 5, wherein, when the transaction is an in-person transaction, the second geographic location at which the data transfer was initiated during use of the interactive device is determined based on reference to a GPS device integrated into the second transceiver associated with the second user.

8. The system transceiver of claim 7, wherein the interactive device is a digital payment feature executable on the second transceiver.

9. The system transceiver of claim 7, wherein the interactive device is a tangible payment card and the second transceiver is a mobile device known to the system transceiver as being associated with the second user.

10. (canceled)

11. The system transceiver of claim 5, wherein, when the transaction is an online transaction, the first geographic location at which the data transfer was initiated during use of the interactive device is determined based on an internet protocol address associated with a third transceiver utilized in conducting the online transaction.

12. (canceled)

13. (canceled)

14. (canceled)

15. (canceled)

16. (canceled)

17. (canceled)

18. (canceled)

19. The system transceiver of claim 1, wherein the system transceiver automatically modifies operation of the system transceiver in real time.

20. A method of operating a system transceiver for interaction with a first transceiver associated with a first user, the method comprising:
determining a first geographic location at which a data transfer is initiated during use of an interactive device associated with a second user, wherein the first geographic location is determined based on transaction-related data routing information;
determining a second geographic location at which the data transfer is initiated during use of the interactive device based on location information obtained from a positioning device associated with a second transceiver of the second user;
determining whether the first geographic location and the second geographic location differ by more than a predefined threshold;
designating the data transfer as a suspect transaction within the system transceiver in reaction to the first geographic location and the second geographic location differing by more than the predefined threshold;
automatically modifying operation of the system transceiver in reaction to the data transfer being designated as a suspect transaction, the modified operation of the system transceiver corresponding to at least one of:
automatically suspending or restricting subsequent transaction activity associated with at least one of the interactive device or a payment card account associated with the interactive device, or
automatically altering a graphical user interface of the first transceiver associated with the first user to include an interactive area redirecting the first transceiver to an interface for suspending or restricting subsequent transaction activity associated with at least one of the interactive device or the payment card account associated with the interactive device.
